(19) United States
(12) Patent Application Publication
(10) Pub. No.: US 2025/0340485 A1
(43) Pub. Date: Nov. 6, 2025

(54) ACID ACTIVATED MIXTURE, CEMENT SLURRY AND STRUCTURE

(71) Applicant: RESTONE AS, STAVANGER (NO)

(72) Inventors: Jill Angelique CLAUSEN, Fyllingsdalen (NO); Eyvind TIME, Bryne (NO)

(73) Assignee: RESTONE AS, STAVANGER (NO)

(21) Appl. No.: 18/855,552

(22) PCT Filed: Apr. 4, 2023
(86) PCT No.: PCT/NO2023/050077

§ 371 Date: Oct. 9, 2024

(30) Foreign Application Priority Data
Apr. 9, 2022 (NO) 20220433

(51) Int. Cl. C04B 22/10; C04B 14/04

(52) U.S. Cl. CPC C04B 22/103; C04B 14/042

(57) ABSTRACT

The invention relates to a relates to an acid activated mixture comprising: an acid activated magnesium-iron solid solution silicate filler; cementitious material; and carbon dioxide (CO2); wherein the magnesium-iron solid solution silicate filler has at most 7% free water, and wherein the magnesium-iron solid solution silicate filler is between 4% and 55% by weight of cementitious material. The invention further relates to a method for producing an acid activated cement slurry comprising the steps: making a slurry comprising a non-acid activated or acid activated magnesium-iron solid solution silicate filler, water, and cementitious material; adding carbon dioxide (CO2) to the slurry; and optionally adding an acid to the slurry; wherein the magnesium-iron solid solution silicate filler is between 4% and 55% by weight of cementitious material. The invention also relates to a process for making an acid activated structure, an acid activated cement slurry obtainable by the method, use of the acid-activated cement slurry for making an acid activated structure, aspect, and an acid activated structure obtainable by the process.

### FIELD OF THE INVENTION

The invention pertains to an acid activated mixture, a method for producing an acid activated cement slurry, an acid activated cement slurry obtained by the method, use of the acid activated cement slurry, a process for making an acid activated structure, and an acid activated structure obtained by the process. More specifically, the present invention relates to an acid activated mixture, slurry and structure comprising an acid activated magnesium-iron solid solution silicate filler, cementitious material, carbon dioxide, and optionally an acid.

### BACKGROUND OF THE INVENTION

The use of additives for cement and concrete has developed strongly since the 1960s. The motive has been a desire to achieve all the good properties of concrete while avoiding the unfortunate. With today's modern casting techniques and complicated constructions, they have become completely dependent on the additive. One such additive is air entrainment material (air entraining concrete admixture). This is a liquid air-entraining concrete mixture formulated from modified naturally occurring and synthetic surfactants.

This meets the requirements of EN 934-2, and promotes the distribution of microscopic air bubbles through the cement matrix.
Applications that require high resistance to freezing/thawing cycles
Concrete that will be exposed to tidal conditions, splash zones and de-icing salts
This provides features and benefits, provides consistent bubble size and spacing
Improved cohesion
Improved machinability
Improved rheology
Reduced permeability, reduced bleeding
Reduced latency, increases the concrete's resistance to frost attack
Reduced loss of air from fresh concrete

The density of the concrete includes density against liquids, gases and ions are important both in terms of the structures' function and durability.

Durability is largely dependent on the fact that aggressive liquids and gases do not penetrate into the concrete. In addition to the transport of liquids and gases, there will be a transport of ions in stagnant liquids (water) in the pore system. This is called diffusion.

The density of the concrete against liquid transport due to pressure gradients is primarily controlled by the mass ratio (W/C ratio) and the curing time. Low mass ratio leads to small pore volume and smaller proportion of coarse pores and thus a relatively dense concrete.

In concrete constructions, any cracks and degree of compaction will also play a certain role in the density of the concrete. Density in cement adhesive depends on the size distribution of the pores, and how well they stick together. The fine gel pores are the connections, but due to the small dimensions, much of the water is physically bound to the surfaces and will to a small extent function as transport routes.

Transport mechanisms/diffusion of ions dissolved in the pore water is a result of concentration gradients inwards in the pore water of the concrete for the type of ion in question.

In concrete structures there can be a number of different types of damage depending on the environmental stresses. Damage due to long-term degradation mechanisms, damage as reinforcement corrosion due to the pore water has a falling pH value and does not seal the oxide layer on the steel. Carbonation of reinforced concrete causes the pH value to drop from about 13 to about 9. This stops the anti-corrosion effect of the concrete and the reinforcement can begin to rust. This leads to cracking and later peeling of the reinforcement cover.

The risk of damage due to carbonation can be reduced by increasing the thickness of the reinforcement's concrete cover but increases the cost dramatically.

The setting process of cement slurries is very complex. Many parameters contribute to the final result. Of these, curing temperature is one of the most important.

The hydration of the cement will drastically slow down or even completely stop in cold conditions. Guidelines suggest that the concrete curing temperature must be maintained at >5° C. (40° F.) for at least 48 hours. The necessary chemical reactions that set and strengthen concrete slow significantly below this temperature. The initial setting and rate of compressive strength development is delayed significantly with decreasing temperature and with increasing W/C ratio. Most lead cement systems used have a high W/C ratio.

To function properly, cements must meet certain physical strength requirements. To meet these requirements, special care must be taken in curing at lower temperatures. Additionally, it is important that the curing of the cement occurs quickly without a reduction in strength.

In arctic subsea wellheads the curing condition for lead cement close to seabed will be low in temperature due to cooling from low seabed seawater temperatures. A suitable compressive strength can take more than 36 hours depending on the slurry temperature and its W/C ratio. Curing cement in low temperatures is not only important for applications in the oil and gas industry, it is also a factor in land-based cementing as well. Many countries experience temperatures that are lower than ideal cementing temperatures. This can for example include basic foundations, superstructures, parking structures, floor construction, tunnel construction and exterior surfaces

Curing has a strong influence on the properties of hardened concrete. Proper curing will increase durability, strength, water tightness, abrasion resistance, volume stability, and resistance to freezing. These properties are affected negatively at low temperature.

WO 2021/179067 relates to the use of amorphous silica reagent as a pozzolane additive in concrete preparation, and discloses a concrete mix comprising a hydraulic binder, sand, aggregates, a cementitious material, an amorphous silica reagent comprising SiO₂ and active MgO.

U.S. Pat. No. 4,422,496 discloses a process for preparing olivine sand cores and moulds.

It would be desirable to provide improved cement structures and processes for producing such improved structures. Further, it would be desired to provide improved mixtures comprising cementitious material and cement slurries that can be used for producing such cement slurries.

### SUMMARY OF THE INVENTION

The present invention solves many of the problems discussed above in the prior art. Acid activation will promote the curing of cement at all temperatures, including low temperatures. This leads to concrete with better construction properties.

Additionally, it is possible to use the present invention in order to sequester carbon dioxide and increase to pourability of a cement slurry. The invention makes it possible to form a protective layer to protect a cement structure from the effects of carbonation without requiring a large increase in thickness of a cement structure.

Magnesium-iron solid solution silicates can absorb CO₂ through a carbonation process as described herein. This is particularly useful for reduction of CO₂ during the curing process itself. Additionally, it can absorb CO₂ from the environment surrounding the curing process.

The more magnesium-iron solid solution silicates in the cement blend, the less overall CO₂ is produced and the more CO₂ that is absorbed. Additionally, the additional amount of magnesium-iron solid solution silicates that are present will also increase the amount of CO₂ that is absorbed. This absorption is at least partially due to a carbonation reaction.

Thus, one of the objects of the present invention is to use magnesium-iron solid solution silicates as a filler which can activate the cement slurry such that the cement reaction occurs at a low temperature. This allows a stronger cement, in a cold temperature environment. Additionally, this allows for a cement with a higher W/C ratio to still maintain properties of high enough strength for the associated task. It can also cause the cement reaction to occur at a higher speed.

Another object of the present invention is to provide a method of increasing the speed of the cementing reaction at normal cementing temperatures.

Yet another object of the present invention is to provide cement structures showing a better resistance to carbonation. Such an improvement may lead to a smaller carbonation depth when the cement structures are exposed to CO₂.

A further object of the present invention is to provide improved mixtures, cement slurries and structures as well as methods for the production thereof.

Accordingly, in one aspect, the present invention relates to an acid activated mixture comprising:
an acid activated magnesium-iron solid solution silicate filler,
cementitious material; and
carbon dioxide (CO₂);
   wherein the magnesium-iron solid solution silicate filler has at most 7% free water, and wherein the magnesium-iron solid solution silicate filler is between 4% and 55% by weight of cementitious material.

In another aspect, the present invention relates to a method for producing an acid activated cement slurry comprising the steps:
a) making a slurry comprising a non-acid activated or acid activated magnesium-iron solid solution silicate filler, water, and cementitious material;
b) adding carbon dioxide (CO₂) to the slurry; and
c) optionally adding an acid to the slurry;
   wherein the magnesium-iron solid solution silicate filler is between 4% and 55% by weight of cementitious material.

In yet another aspect, the present invention relates to a process for making an acid activated structure comprising the steps:
i) making a slurry comprising a non-acid activated or acid activated magnesium-iron solid solution silicate filler, water, and cementitious material;
ii) introducing the slurry to a form;
iii) allowing the slurry to cure;
iv) adding carbon dioxide (CO₂) to the slurry; and
v) optionally adding an acid to the slurry;
   wherein the magnesium-iron solid solution silicate filler is between 4% and 55% by weight of cementitious material.

In yet another aspect, the present invention relates to an acid activated cement slurry obtainable by the method as defined herein.

In yet another aspect, the present invention relates to the use of the acid-activated cement slurry as defined herein for making an acid activated structure.

In yet another aspect, the present invention relates to an acid activated structure obtainable by the process as defined herein.

These and other objects and aspects of the invention will be described in further detail hereinafter.

### Definitions and Processes

### Hydration of Cement

Water when mixed with cement, forms a paste that binds the aggregate together. The water causes the hardening of concrete through a process called hydration. Hydration is a chemical reaction in which the major compounds in cement form chemical bonds with water molecules and become hydrates or “create” hydration products.

While there are several chemical reactions involved in the mixing of cement and water, there are two main exothermic reactions which that are responsible for the strength of the cured product:

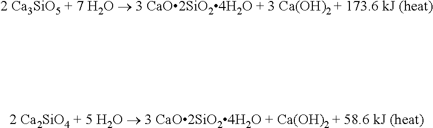

These reactions are sensitive to temperature and slowdown (or stop) at low temperatures. Temperatures below 10° C. (50° F.) are unfavorable for the development of early strength; below 4° C. (40° F.) the development of early strength is greatly retarded; and at or below freezing temperatures, down to −10° C. (14° F.), little or no strength develops. It is for this reasons that a cement slurry is poured at temperatures above 15° C.

### Hydration of Magnesium-Iron Solid Solution Silicates

The hydration reactions described here happen at the very low end of the pressure- and temperature range generally discussed in metamorphic petrology. Diagenesis, weathering and very low grade metamorphism are the main processes. In geochemical reactions, an added forcing on a reaction can be geochemical instabilities, where minerals or solutions not in equilibrium seeks to react towards a steady state. In the invention, anthropogenically induced geochemical instabilities may be utilized to induce low, very low grade metamorphism, diagenesis and weathering. Overtime, even olivine grains covered in an aqueous solution and left at room temperature will weather to alteration minerals.

Below is shown some of the reactions of end-member olivine (forsterite and fayalite) when hydrated in reaction with H₂O. It may occur according to these but not limited to the following reaction equations:

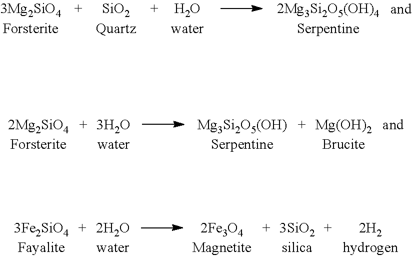

Note that forsterite is the magnesium endmember of the olivine solid solution series and fayalite would be the divalent iron endmember of the olivine solid solution series. an olivine with 90% forsterite would be assigned fo90. A solid solution mineral series allows cations of similar size and valency can be exchanged in the same location in the crystal lattice, based on the external forces that they are exposed to. For olivine in natural systems, the magnesium endmember indicates higher crystallization temperatures than the iron endmember does. Therefore, the mantle rocks predominantly exist of fo93-fo89 olivine. Pure forsterite is rare in nature.

According to the present invention, a similar reaction pattern of magnesium-iron silicates in hydration reactions (with water (H₂O) and associated aqueous solutions (e.g. brines)) may be used, such that the composition may be used as enhancers in cementitious mineral admixture materials, as a pozzolan, a latent hydraulic binder, as a filler, for the use of producing amorphous silica in the latent reaction, and to provide a natural anti-fouling agent in cementitious concrete and/or mortar structures in general.

### Magnesium-Iron Solid Solution Silicates

The term “divalent magnesium-iron solid solution silicates”, as used herein, is a term of the art in geological and mineralogical sciences. A common short-hand term in the art is “magnesium-iron silicates”. In natural earth-based systems, there are more magnesium ions than iron ions present.

Magnesium-iron silicates have variable compositions due to “solid-solution” chemistry mainly involving Mg²⁺ and Fe²⁺ ions. These are silicate systems where iron and magnesium ions can occupy the same place in the mineral. This is called substitution and can occur over the complete range of possible compositions because iron and magnesium have a similar atomic radius (Fe⁺²=0.78 Å and Mg⁺²=0.72 Å) and can have the same valence state.

As an example, the formula for olivine is often given as: (Mg,Fe)₂SiO₄. To one skilled in the art, olivine can be thought of as a mixture of Mg₂SiO₄ (forsterite—Fo) and Fe₂SiO₄ (fayalite—Fa). If there is more forsterite than fayalite (thus more magnesium than iron), it can be referred to as a magnesium-iron silicate. If there was more fayalite than forsterite, then it can be referred to as an iron-magnesium silicate.

As another example, the formula for orthopyroxene is often given as: (Mg,Fe)₂Si2O₆. To one skilled in the art, olivine can be thought of as a mixture of Mg₂Si₂O₆(Enstatite—En) and Fe₂Si2O₆ (Ferrosilite). Orthopyroxenes always have some Mg present in nature and pure Ferrosilite is only made artificially. Orthopyroxene with more Mg than Fe is referred to as a magnesium-iron silicate. If there was more ferrosilite than enstatite, then it can be referred to as an iron-magnesium silicate.

### Fillers

The term “fillers”, as used herein, refers to materials whose function in concrete is based mainly on size and shape. They can interact with cement in several ways; to improve particle packing and give the fresh concrete other properties, and even to reduce the amount of cement in concrete without loss of strength. Ideally, fillers partially replace cement and at the same time improve the properties and the microstructure of the concrete. Examples of suitable fillers include quartz, limestone, and other non-alkali-reactive aggregates. Replacement of cement by a filler will often lead to a more economical product and improved the properties of the cured concrete.

It is known that filler type and content may have significant effect on fresh concrete properties where non-pozzolanic fillers improve segregation and bleeding resistance. Generally, filler type and content may have a significant effect on unit weight, water absorption and voids ratio. In addition, non-pozzolanic fillers may have an insignificant negative effect on concrete compressive strength.

As defined in NS-EN 12620 is filler the aggregate with grains less than 2 mm. Filler has a grain size where most of the grains pass 0.063 mm sieve. Fillers may be added to concrete in building materials to give certain properties. Filler is the finest grain fraction in aggregates for concrete and mortar. The fraction with a grain diameter below 0.125 mm is called filler sand.

If the filler content becomes too large, the water demand may increase, and reduced firmness and increased shrinkage can be the result.

### Carbonation

The prior art discloses many examples of cement mineral mixtures for producing concrete to defend the cement construction from a reaction with CO₂, named a carbonation process. Carbonation is a well-known reaction for all lime-cement mixtures and changes its mineral composition from CaO (lime) to CaCO₃ (Calcium carbonate) and this happens naturally over time due to weathering. The magnesium-iron silicates will also react with the CO₂ and the minerals formed due to carbonation will expand into gaps and cracks of the cementitious structure in order to keep the structure sealed.

Magnesium-iron silicates can be carbonized (e.g. altered by CO₂), and therefore will increase the cement-plug lifetime for the cement admixtures in wells when exposed to CO₂, particularly those penetrating carbon-dioxide storage (CCS) reservoirs. The reaction of olivine with CO₂ may produce magnesium carbonate, creating a self-healing cement in actual conditions in the well.

Below is an example of a carbonation process of the magnesium end member olivine reacting with carbon dioxide.

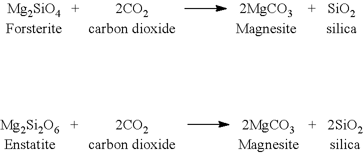

The carbonation process example happens naturally, where CO₂ reacts with the forsterite endmember of the olivine solid solution series.

### Dry Mixture

In chemistry the term “dry” can be difficult to formulate. On one end of the scale is anhydrous (no water) and on the other end is a slurry (enough water to make the mixture a liquid). Another concern when dealing with a magnesium-iron solid solution silicate is the fact that water can be trapped within the crystal matrix. The water that is surrounding the outside of the crystal structure is known as free water. “Dry” unless otherwise specified will refer to a free water content of 7% or less, preferably a free water content of 7% by weight or less.

### Acid

The term “acid”, as used herein, refers to both strong and weak acids. The term “strong acid”, as used herein, refers to an acid which dissociates completely into its ions in water, yielding one or more protons (hydrogen cations) per molecule. Examples of suitable strong acids include HCl (hydrochloric acid), HNO₃ (nitric acid), H₂SO₄ (sulfuric acid), HBr (hydrobromic acid), HI (hydroiodic acid), HClO₄ (perchloric acid), and HClO₃ (chloric acid).

The term “weak acid”, as used herein, refers to an acid which does not completely dissociate into its ions in water. For example, HF dissociates into the H⁺ and F⁻ ions in water, but some HF remains in solution, so it is not a strong acid. Examples of suitable weak acids include HO₂C₂O₂H (oxalic acid), H₂SO₃ (sulfurous acid), HSO₄⁻ (hydrogen sulfate ion), H₃PO₄ (phosphoric acid), HNO₂ (nitrous acid), HF (hydrofluoric acid), HCO₂H (methanoic acid), C₈H₅COOH (benzoic acid), CH₃COOH (acetic acid), HCOOH (formic acid), and H₂CO₃ (carbonic acid).

### Acid Activated or Activated

A magnesium-iron solid solution silicate filler that has been in contact with an acid, e.g. any of the acids mentioned herein, is herein referred to as an “acid activated magnesium-iron solid solution silicate filler”. If the filler has not been in contact with the acid, it will be referred to as a “non-activated magnesium-iron solid solution silicate filler”. An acid activated magnesium-iron solid solution silicate filler, may also be referred to as an “acid-activated filler” or an “activated filler”. A non-acid activated magnesium-iron solid solution silicate filler may be referred to as a “non-activated filler” or “non-acid activated filler”.

The term “activator”, as used herein, is used as a shorthand for the property of the activated filler to speed up the cement reaction, i.e. faster setting of the concrete, and/or allow the reaction to occur at all. One example is low temperature casting which may be impossible without an activator to start the reaction.

A cement slurry that uses the acid activated magnesium-iron solid solution silicates filler may be referred to herein as “activated cement slurry”. A mixture, or dry mixture, comprising an acid activated magnesium-iron solid solution silicate may be referred to as an “acid activated mixture” or “activated mixture”. A slurry comprising an acid activated magnesium iron solid solution silicate may be referred to as an acid activated cement slurry or activated cement slurry. A structure that is made from an acid activated magnesium-iron solid solution silicate may be referred to as an “acid activated structure” or “activated structure”.

### Cementitious Material

The term “cementitious material”, as used herein, refers to any cementitious material such as, for example, any cement, Portland cement and alkaline cement.

### Structure and Form

The term “structure”, as used herein, refers to a concrete casting. This is where a cement slurry is added to a form and allowed to cure. The curing time and when the form is removed will depend upon the application. Often the form will be removed well before the concrete is able to take a full load (industry standard is 28 days) or afterwards. In some applications, the concrete is entirely cured before the form is removed.

The term “form”, as used herein, refers to a solid barrier that holds concrete in place or forces concrete to assume a certain shape during the curing process. Examples of suitable forms, or concrete forms, include wood forms, cardboard tubes, and insulated concrete forms. In the case of mortar, the bricks that are in contact with the mortar act as the form. In the case of cement slurry applied onto a vertical surface (e.g. tunnel wall), the form is the surface it is being applied to. Vertical in this case is not meant to only apply to angles of 90 degrees to a level surface.

### DETAILED DESCRIPTION OF THE INVENTION

Reference will now be made in detail to the present invention and embodiments thereof. Alternative embodiments will also be presented. This invention may, however, be embodied in many different forms and should not be construed as limited to the embodiments set forth herein. These embodiments are provided by way of illustration only. Several further embodiments, or combinations of the presented embodiments, will be within the scope of one skilled in the art.

The acid activated mixture according to the invention comprises an acid activated magnesium-iron solid solution silicate filler; cementitious material; and carbon dioxide; wherein the magnesium-iron solid solution silicate filler has at most 7% free water, preferably at most 7% by weight of free water.

The method for producing an acid activated cement slurry according to the invention comprises the steps of making a slurry comprising a non-acid activated or acid activated magnesium-iron solid solution silicate filler, water, and cementitious material; adding CO₂ to the slurry; and optionally adding an acid to the slurry.

The process for making an acid activated structure according to the invention comprises the steps of making a slurry comprising a non-acid activated magnesium-iron solid solution silicate filler, water, and cementitious material; introducing the slurry to a form; allowing the slurry to cure; adding CO₂ to the slurry; and optionally adding an acid to the slurry.

In the mixture, method and process according to the invention, the magnesium-iron solid solution silicate filler is preferably earth based, or in the form of an earth based rock or mineral. Further, the magnesium-iron solid solution silicate filler may be selected from olivines, orthopyroxenes, amphiboles, and serpentines, preferably olivine. Suitably, the magnesium-iron solid solution silicate filler is between 4% and 55% by weight of cementitious material, preferably between 15% and 30% by weight of cementitious material. The cementitious material may be selected from Portland cement and alkaline cement, preferably alkaline cement.

Examples of acids according to the mixture, method and process of the invention include the acids mentioned above, and example of preferred acids include H₂CO₃, HCOOH, CH₃COOH, HCl, HNO₃, H₂SO₄ and mixtures thereof. In a preferred embodiment, the acid preferably has a pH of between 1 and 3.

According to the mixture, method and process of the invention, the addition of carbon dioxide (CO₂) to the mixture or slurry preferably generates an acid in situ. The addition of CO₂ to the mixture or slurry may take place by adding CO₂ in gaseous, solid or liquid form, suitably by adding CO₂ gas, and preferably by bubbling CO₂ gas through the mixture or slurry. According to the process of the invention, CO₂ may be added to the slurry at step i), step ii), or step, iii), or between step i) and step ii), or between step ii) and step iii).

According to the method and process of the invention, is to add carbon dioxide (CO₂) to a non-activated cement slurry of, at least, cement, water, and non-activated magnesium-iron solid solution silicate filler. One way to do this is to bubble CO₂ gas through the slurry. In this way the CO₂ gas will be absorbed before a structure is made. Without being bound to any theory, it is believed that the combination of water and CO₂ results in making H₂CO₃ (carbonic acid). While the carbonic acid will be neutralized in the cement slurry (as discussed previously), it will not be in the area immediately in contact with the non-acid activated magnesium-iron solid solution silicate filler. This contact will produce an acid activated magnesium-iron solid solution silicate filler in situ, resulting in an activated cement slurry.

Bubbling of CO₂ also has effects on the slurry itself. The bubbles in the slurry make it easier to pour into the form. These bubbles can be removed through normal means of vibration and other well-known methods in the art. However, according to preferred embodiments of the invention, the structure comprises bubbles of CO₂. Hereby the structure or concrete may better tolerate the expansion/freezing cycle in cold climates.

According to the mixture, method and process of the invention, an acid may be added to the mixture or slurry and in a preferred embodiment an acid is added to the mixture or slurry. According to the method and process of the invention, when the mixture or slurry comprises a non-acid activated magnesium-iron solid solution silicate filler, an acid is preferably added to the slurry. According to the process of the invention, the acid may be added to the slurry at step i), step ii), or step, iii), or between step i) and step ii), or between step ii) and step iii).

The process of the invention comprises a step of allowing the slurry to cure. The temperature of the curing may be between 0° C. and 15° C., or between 0° C. and 5° C., or between 5° C. and 15° C.

The acid activated cement slurry according to the invention is obtainable by the method as defined herein. The acid-activated cement slurry according to the invention is suitable for use in making an acid activated structure, and the present invention also relates to the use of the acid activated cement slurry according to the invention making an acid activated structure. The acid activated structure according to the invention is obtainable by the process as defined herein.

According to the invention, it has been found that a magnesium-iron solid solution silicate filler can “activate” the cement reaction when it is mixed with an acid. It is preferable that this magnesium-iron solid solution silicate is in the form of an earth based rock or mineral.

According to the invention, an acid activated mixture is a combination of an acid activated magnesium-iron solid solution silicate filler and cementitious material. One way of manufacturing an acid activated filler is to combine non-acid activated magnesium-iron solid solution silicate filler with an aqueous acid. Examples of suitable acids include the acids described herein. The acid would then be allowed to react with the filler. A pH range of between pH 1 and pH 3 is preferred, e.g. a pH of about 2. The weight of acid activated filler is suitably between 4% and 55%, and preferably between 15% and 30%, by weight of cementitious material.

The length of contact time between the acid and the filler may depend on the concentration of the acid and the type of acid. The filler may then be separated from the aqueous acid. This may be done by several methods. One example is to put the mixture through a filter of a size that would strain out the filler but allow for the aqueous acid to pass through. Another example is to apply heat to the mixture until the acid is evaporated away. These two examples could be combined or used separately. This process of manufacturing the acid activated mixture may also be repeated on an already acid activated magnesium-iron solid solution silicate filler if the concentration of acid on the filler needs to be increased.

The method and process of the invention comprises making a slurry comprising a non-acid activated or acid activated magnesium-iron solid solution silicate filler, water, and cementitious material. The slurry can be prepared by mixing the non-acid activated or acid activated magnesium-iron solid solution silicate filler, water, and cementitious material in any order. For example, the slurry can be prepared by:
(i) adding water to a mixture of non-acid activated or acid activated magnesium-iron solid solution silicate filler and cementitious material;
(ii) adding water to a mixture of non-acid activated magnesium-iron solid solution silicate filler and cementitious material;
(iii) adding water to a mixture of acid activated magnesium-iron solid solution silicate filler and cementitious material;
(iv) mixing cementitious material, non-acid activated magnesium-iron solid solution silicate filler, and water;
(v) mixing cementitious material, acid activated magnesium-iron solid solution silicate filler, and water;
(vi) adding acid activated magnesium-iron solid solution silicate filler to a mixture of cementitious material and water;
(vii) adding non-acid activated magnesium-iron solid solution silicate filler to a mixture of cementitious material and water;
(viii) adding cementitious material to a mixture of acid activated magnesium-iron solid solution silicate filler and water; and
(ix) adding cementitious material to a mixture of non-acid activated magnesium-iron solid solution silicate filler and water.

According to the method and process of the invention, the carbon dioxide (CO₂) and/or acid may be added to the slurry prepared as defined in (i) to (ix) above, and the carbon dioxide (CO₂) and/or acid may be combined with the non-acid activated magnesium-iron solid solution silicate filler, acid activated magnesium-iron solid solution silicate filler, cementitious material, water and any mixtures thereof.

According to the process of the invention, the acid may be added to the structure by different methods. When using a non-acid activated magnesium-iron solid solution silicate filler, it is not required that all the non-acid activated magnesium-iron solid solution silicate contact the acid. The acid may be applied to a surface, and then activate the filler that it is in contact with. The portion that is activated may generate heat and accelerate the curing process throughout the structure, when compared to not having an activated filler.

According to the process of the invention, the acid may be introduced to at least one surface of a form. This can be by spraying, painting, pouring, using a gel, or other suitable ways of getting acid to remain in place on the form. Then a non-activated cement slurry may be added to the form and allowed to cure.

According to the process of the invention, the non-activated cement slurry may be added to a form. Before the curing process is completed, acid is applied to at least one surface of the structure. One example of this is to remove the form and then apply the acid. Another example is to apply the acid to a surface that is not covered by the form.

According to the process of the invention, the non-activated cement slurry may be added to a form. Before the curing process is completed, CO₂ may be applied to at least one surface of the structure.

While the preferred magnesium-iron solid solution silicate filler is olivine, other examples include orthopyroxenes, amphiboles, and serpentines. The magnesium-iron solid solution silicate filler as an activator will also function for higher temperatures. In this case, the cement reaction will occur faster than without this filler.

The magnesium-iron solid solution silicate as an activated filler may act as an activator to allow for the cement reactions to occur on a shorter timeframe than normal. Experiments performed between 0-5° C. show a setting of cement below the recommended curing temperature of cement. It is not expected that the cement will cure at this temperature before 28 days. Note that the range of 5-15° C. is also considered to be cold with curing times expected to take 24-48 hours. The addition of the magnesium-iron solid solution silicates may lower this curing time with no significant loss of strength.

This reduction of curing time, i.e. the cement reaction speed is increased, may also occur at temperatures above 15° C. into more typical temperatures of cement curing.

### EXAMPLES

The invention is further illustrated in the following examples which, however, are not intended to limit the same. Parts, % and ratios relate to parts by weight, % by weight, and weight ratios, respectively, unless otherwise stated.

### Example 1

Mixtures, cement slurries and structures according to the invention and corresponding products used for comparison were prepared, and the obtained structures were tested and evaluated in terms of resistance to carbonation.

Four different cementitious materials, or cements, were used. The filler used according to the invention was olivine, which was non-acid activated prior to subjecting the obtained slurries or mixtures to carbon dioxide (CO₂). The filler used for comparison was quartz. The mixtures obtained and the amount of components used are evident from Table 1. The slurries were made by mixing the cementitious material with the filler, and then adding water to the mixture obtained.

For the testing, samples having a size of 40/40/160 mm were cast from each mixture. The samples were stored for 13 days in water after demolding before exposing the samples to air containing 1% CO₂ at 20° C. and 60% RH in a cabinet. Measurement of carbonation depth was carried out after 4, 8, 12 and 22 weeks of exposure in the cabinet.

The mixtures and results are shown in Table 1.

TABLE 1

| Mixture | | | 1 | 2 | 3 | 4 | 5 | 6 | 7 | 8 |
|---|---|---|---|---|---|---|---|---|---|---|
| Norcem construction cement [g] | | | 450 | | | | 450 | | | |
| Norcem standard cement FA [g] | | | | 450 | | | | 450 | | |
| Norcem environmental cement [g] | | | | | 450 | | | | 450 | |
| Schwenk CEM IIIB [g] | | | | | | 450 | | | | 450 |
| Water [g] | | | 270 | | | | | | | |
| Water/Cement (W/C) | | | 0.60 | | | | | | | |
| Olivine [g] | | | | | | | 90 | 90 | 90 | 90 |
| Quartz flour [g] | | | 90 | 90 | 90 | 90 | | | | |
| Standard sand [g] | | | 1350 | | | | | | | |
| 1% CO₂ | 4 | weeks | — | 5.7 | — | 9.1 | — | 5.6 | — | 8.3 |
| | 8 | weeks | 4.5 | 7.6 | — | 12.7 | 4.3 | 7.5 | — | 11.6 |
| | 12 | weeks | — | 10.2 | 8.8 | 16.9 | — | 9.5 | 8.5 | 15.6 |
| | 22 | weeks | 7.7 | 15.6 | 12.8 | — | 6.8 | 14.5 | 11.6 | — |

As is evident from Table 1, the samples (structures) prepared from mixtures (cement slurries) according to the invention showed a smaller carbonation depth after 4, 8, 12 and 22 weeks of exposure to 1% CO₂, thus a better resistance to carbonation, over the samples used for comparison.

### Example 2

The procedure according to Example 1 was repeated except that sample preparation was slightly different and an acid was co-used in preparing the samples. As in Example, the samples obtained were tested and evaluate in terms of resistance to carbonation.

The samples were stored for one day in the form, 3 days in water and 3 days in air of 65% RH before acid treatment, in which 5% hydrochloric acid (HCl) and 5% nitric acid (HNO₃) were used. The acid treatment was carried out by immersing one sample from each mixture for 12 minutes in hydrochloric acid (HCl) and nitric acid (HNO₃), respectively. Each sample used as a reference was immersed in pure water.

After the treatment with acid and water, respectively, the samples were packed together in plastic foil. After 15 days, the samples were unpacked and placed in a cabinet with air of 1% CO₂ at 20° C. and 60% RH. Splitting and measurement of carbonation depth was carried out after 4, 9 and 22 weeks of exposure.

The mixtures and results are shown in Table 2.

TABLE 2

| Mixture | | 9 | 10 | 11 | 12 |
|---|---|---|---|---|---|
| Norcem construction cement [g] | | 450 | | | |
| Norcem standard cement FA [g] | | | 450 | | |
| Norcem environmental cement [g] | | | | 450 | |
| Schwenk CEM IIIB [g] | | | | | 450 |
| Water [g] | | 270 | | | |
| W/C | | 0.60 | | | |
| Olivine [g] | | 90 | 90 | 90 | 90 |
| Quartz flour [g] | | 90 | 90 | 90 | 90 |
| Standard sand [g] | | 1350 | | | |
| Reference | 4 weeks | 3.4 | 5.7 | 5.1 | 10.2 |
| HNO₃ | 1% CO₂ | 2.3 | 4.6 | 4.4 | 9.8 |
| HCl | | 2.6 | 5.1 | 4.5 | — |
| Reference | 9 weeks | 4.7 | 8.5 | 7.8 | 15.8 |
| HNO₃ | 1% CO₂ | 3.3 | 7.8 | 6.3 | 15.0 |
| HCl | | 4.0 | 8.1 | 7.0 | — |
| Reference | 22 weeks | 6.8 | 15.0 | 12.0 | — |
| HNO₃ | 1% CO₂ | 5.5 | 13.0 | 9.8 | — |
| HCl | | 6.3 | 13.8 | 11.3 | — |

As is evident from Table 2, the samples (structures) prepared from acid activated (treated) mixtures and cement slurries according to the invention showed a smaller carbonation depth after 4, 9 and 22 weeks of exposure to 1% CO₂, thus a better resistance to carbonation, over the samples used for comparison.

1. An acid activated mixture comprising:
an acid activated magnesium-iron solid solution silicate filler;
cementitious material; and
carbon dioxide (CO₂);
wherein the magnesium-iron solid solution silicate filler has at most 7% free water; and
wherein the magnesium-iron solid solution silicate filler is between 4% and 55% by weight of cementitious material.

2. A method for producing an acid activated cement slurry comprising the steps:
a) making a slurry comprising a non-acid activated or acid activated magnesium-iron solid solution silicate filler, water, and cementitious material;
b) adding carbon dioxide (CO₂) to the slurry; and
c) optionally adding an acid to the slurry;
wherein the magnesium-iron solid solution silicate filler is between 4% and 55% by weight of cementitious material.

3. A process for making an acid activated structure comprising the steps:
i) making a slurry comprising a non-acid activated or acid activated magnesium-iron solid solution silicate filler, water, and cementitious material;
ii) introducing the slurry to a form;
iii) allowing the slurry to cure;
iv) adding carbon dioxide (CO₂) to the slurry; and
v) optionally adding an acid to the slurry;
wherein the magnesium-iron solid solution silicate filler is between 4% and 55% by weight of cementitious material.

4. The mixture according to claim 1, wherein the magnesium-iron solid solution silicate filler is earth based, or in the form of an earth based rock or mineral.

5. The mixture according to claim 1, wherein the magnesium-iron solid solution silicate filler is selected from olivines, orthopyroxenes, amphiboles, and serpentines, preferably olivine.

6. The mixture according to claim 1, wherein the magnesium-iron solid solution silicate filler is between 15% and 30% by weight of cementitious material.

7. The mixture according to claim 1, wherein the cementitious material is Portland cement or alkaline cement, preferably an alkaline cement.

8. The mixture according to claim 1, wherein the acid has a pH of between 1 and 3.

9. The mixture according to claim 1, wherein the acid is H₂CO₃, HCOOH, CH₃COOH, HCl, HNO₃ and/or H₂SO₄.

10. The method according to claim 2, wherein adding carbon dioxide (CO₂) to the slurry generates an acid in situ.

11. The method according to claim 2, wherein adding carbon dioxide (CO₂) to the slurry comprises adding CO₂ gas, preferably bubbling CO₂ gas through the slurry.

12. The method according to claim 2, wherein adding carbon dioxide (CO₂) to the slurry comprises adding CO₂ in a solid or liquid form.

13. The method according to claim 2, wherein it comprises adding an acid to the slurry.

14. The method according to claim 2, wherein the slurry is made by adding water to a mixture of non-acid activated or acid activated magnesium-iron solid solution silicate filler and cementitious material.

15. The process according to claim 3, wherein carbon dioxide (CO₂) is added to the slurry at step i), step ii), or step, iii), or between step i) and step ii), or between step ii) and step iii).

16. The process according to claim 3, wherein an acid is added to the slurry at step i), step ii), or step, iii), or between step i) and step ii), or between step ii) and step iii).

17. The process according to claim 3, wherein the temperature of the curing is between 0° C. and 15° C., or between 0° C. and 5° C., or between 5° C. and 15° C.

18. An acid activated cement slurry obtainable by the method according to claim 2.

19. Use of the acid-activated cement slurry according to claim 18 for making an acid activated structure.

20. An acid activated structure obtainable by the process according to claim 3.
